(19) United States
(12) Patent Application Publication
(10) Pub. No.: US 2026/0279359 A1
(43) Pub. Date: Sep. 17, 2026

(54) METHOD AND SYSTEM FOR TEMPORAL VOICE-BASED ASSISTANCE FOR REMOTE EVENTS

(71) Applicant: SAMSUNG ELECTRONICS CO., LTD., Suwon-si (KR)

(72) Inventors: Siba Prasad SAMAL, Bangalore (IN); Mukunth A, Bangalore (IN); Suyambulingam Rathinasamy MUTHUPANDI, Bangalore (IN); Jay SHARMA, Bangalore (IN); Chiranjeevi A R HEGDE, Bangalore (IN); Ankit JAIN, Bangalore (IN); Aditya CHAURASIA, Bangalore (IN); Adarsh, Bangalore (IN); Partha Pratim MALAKAR, Bangalore (IN); Kshitij PATEL, Bangalore (IN); Hement RAWAL, Bangalore (IN); Kodam NAGARAJU, Bangalore (IN)

(73) Assignee: SAMSUNG ELECTRONICS CO., LTD., Suwon-si (KR)

(21) Appl. No.: 19/678,830

(22) Filed: May 15, 2026

Related U.S. Application Data
(63) Continuation of application No. PCT/KR2024/096626, filed on Nov. 18, 2024.

(30) Foreign Application Priority Data
Nov. 17, 2023 (IN) 202341078288

(51) Int. Cl. G10L 15/22; G06F 16/334; G06F 40/30

(52) U.S. Cl. CPC G10L 15/22; G06F 16/334; G06F 40/30

(57) ABSTRACT

A method for performing voice-based assistance by a processor of a first electronic device associated with a host user includes receiving, from a second electronic device associated with an invitee user, a query related to a remote event associated with a smart environment; determining, based on information on the invitee user and the host user hosting the remote event, an access level of the invitee user to access the smart environment; and transmitting, using a natural language (NL) database, a response to the received query to the second electronic device based on the determined access level of the invitee user.

### CROSS-REFERENCE TO RELATED APPLICATIONS

This application is a continuation of PCT International Application No. PCT/KR2024/096626, which was filed on Nov. 18, 2024, and claims priority to Indian Patent Application number 202341078288, filed on Nov. 17, 2023, in the Indian Patent Office, the disclosures of each of which are incorporated by reference herein their entirety.

### BACKGROUND

### 1. Field

The disclosure generally relates to a field of smart home and artificial intelligence (AI) technology, and particularly relates to a method and system for temporal voice-based assistance for remote events associated with a smart home environment.

### 2. Description of Related Art

In recent years, voice-based assistance systems have become increasingly popular. A voice-based assistance system is an application that can interact with users through speech recognition, natural language understanding, and speech synthesis technologies. The voice-based assistance system performs various tasks such as answering questions, providing information, and controlling devices. A conventional voice-based assistance system provides voice-based assistance to users based on their context, such as their location, time, schedule, preferences, and history. Such conventional voice-based assistance system helps the users to perform various tasks, such as making appointments, booking travel, ordering food, or getting directions.

However, in the conventional voice-based assistance system the users are unable to query the devices of another user in a privacy-aware manner. The conventional voice-based assistance system does not provide remote interaction among users to coordinate for events or occasions in the privacy-aware manner. Also, another limitation is that the conventional voice-based assistance system may not be able to handle complex or ambiguous queries that require information from other devices. For example, the conventional voice-based assistance system may not be able to answer queries where sharing knowledge from the other devices is necessary. In order to solve the above-mentioned issue, the conventional voice-based assistance system may operate on a distributed and interconnected network, such as a virtual assistant platform (VAP). Such conventional voice-based assistance system can communicate with users via an electronic device, and can also communicate with other devices via voice-based assistance systems of the other devices.

However, the conventional voice-based assistance system that operates on the distributed and interconnected network may lack security concerns about how much knowledge from one device needs to be shared. Further, the conventional voice-based assistance system that operates on the distributed and interconnected network may also not be able to provide voice-based assistance on events which are not related to a device associated with the user.

Therefore, there is a need for an improved method and device that can overcome all the above-discussed limitations and problems of the conventional voice-based assistance system.

### SUMMARY

Additional aspects will be set forth in part in the description which follows and, in part, will be apparent from the description, or may be learned by practice of the presented embodiments.

According to an aspect of the disclosure, a method for performing voice-based assistance by a processor of a first electronic device associated with a host user includes: receiving, from a second electronic device associated with an invitee user, a query related to a remote event associated with a smart environment; determining, based on information on the invitee user and the host user hosting the remote event, an access level of the invitee user to access the smart environment; and transmitting, using a natural language (NL) database, a response to the received query to the second electronic device based on the determined access level of the invitee user.

The determining an intent of the invitee user based on at least one of (i) a determination that the invitee user is invited to the remote event, (ii) an action of the invitee user corresponding to the remote event, or (iii) a degree of association of the received query with the remote event; and providing, based on the determined intent of the invitee user and the determined access level of the invitee user, an access to data associated with the smart environment to the second electronic device.

The information on the invitee user and the host user is based on at least one of (i) a determination that the host user is included in a contact list of the invitee user, (ii) information related to a past communication between the invitee user and the host user, (iii) previously used voice-based assistance communication of the invitee user, or (iv) one or more contexts associated with the remote event.

The method further includes: monitoring, via one or more IoT devices in the smart environment, one or more ongoing activities within the smart environment in relation to the remote event; and storing, at a time instance corresponding to the remote event, information related to the monitored one or more ongoing activities in the NL database in a specified format.

The information related to the monitored one or more ongoing activities is stored in the NL database for a duration until a completion of the remote event.

A timing of the monitoring of the one or more ongoing activities is based on at least one of a start time of the remote event, an end time of the remote event, or a relation of the one or more ongoing activities.

The method further includes correlating the received query with the one or more ongoing activities; retrieving, from the NL database, one or more instances of the one or more activities that are correlated with the received query; and determining the response to the received query based on the retrieved one or more instances.

According to an aspect of the disclosure, a first electronic device for performing voice-based assistance includes a natural language (NL) database; at least one processor including processing circuitry; and memory storing instructions that, when executed by the at least one processor individually or collectively, cause the first electronic device to: receive, from a second electronic device associated with an invitee user, a query related to a remote event associated with a smart environment; determine, based on information on the invitee user and a host user hosting the remote event, an access level of the invitee user to access the smart environment; and transmit, using the NL database, a response to the received query to the second electronic device based on the determined access level of the invitee user.

The instructions, when executed by the at least one processor individually or collectively, further cause the first electronic device to: determine an intent of the invitee user based on at least one of (i) a determination that the invitee user is invited to the remote event, (ii) an action of the invitee user corresponding to the remote event, or (iii) a degree of association of the received query with the remote event; and provide, based on the determined intent of the invitee user and the determined access level of the invitee user, an access to data associated with the smart environment to the second electronic device.

The information on the invitee user and the host user is based on at least one of (i) a determination that the host user is included in a contact list of the invitee user, (ii) information related to a past communication between the invitee user and the host user, (iii) previously used voice-based assistance communication of the invitee user, (iv) or one or more contexts associated with the remote event.

The instructions, when executed by the at least one processor individually or collectively, further cause the first electronic device to: monitor, via one or more IoT devices in the smart environment, one or more ongoing activities within the smart environment in relation to the remote event; and store, at a time instance corresponding to the remote event, information related to the monitored one or more ongoing activities in the NL database in a specified format.

The information related to the monitored one or more ongoing activities is stored in the NL database for a until a completion of the remote event.

A timing of the monitoring of the one or more ongoing activities is based on at least one of a start time of the remote event, an end time of the remote event, or a relation of the one or more ongoing activities with the remote event.

The instructions, when executed by the at least one processor individually or collectively, further cause the first electronic device to: correlate the received query with the one or more ongoing activities; retrieve, from the NL database, one or more instances of the one or more activities that are correlated with the received query; and determine the response to the received query based on the retrieved one or more instances.

According to an aspect of the disclosure, a non-transitory computer readable medium having computer-executable instructions stored therein, which when executed by at least one processor, cause a first electronic device to perform a method including: receiving, from a second electronic device associated with an invitee user, a query related to a remote event associated with a smart environment; determining, based on information on the invitee user and a host user hosting the remote event, an access level of the invitee user to access the smart environment; and transmitting, using the NL database, a response to the received query to the second electronic device based on the determined access level of the invitee user.

### BRIEF DESCRIPTION OF DRAWINGS

The above and other features, aspects, and advantages of the disclosure will become better understood when the following detailed description is read with reference to the accompanying drawings in which like characters represent like parts throughout the drawings, wherein:

FIG. 1 illustrates a simplified diagram of a system for temporal voice-based assistance for a remote event, according to one or more embodiments disclosed herein;

FIG. 2 illustrates a block diagram of the system for temporal voice-based assistance for remote events, according to one or more embodiments disclosed herein;

FIG. 3 illustrates a detailed block diagram of modules of a user device associated with an invitee user, according to one or more embodiments disclosed herein;

FIG. 4 illustrates a detailed block diagram of modules of an electronic device associated with a host user, according to one or more embodiments disclosed herein;

FIG. 5 illustrates a flow chart of a method for performing temporal voice-based assistance for the remote event associated with a smart environment, according to one or more embodiments disclosed herein;

FIG. 6 illustrates a flow chart of a method for storing information related to one or more ongoing activities in a natural language database, according to one or more embodiments disclosed herein;

FIG. 7 illustrates an exemplary use case scenario for user query handling when a user is invited to a birthday party, according to one or more embodiments disclosed herein;

FIG. 8 illustrates an exemplary use case scenario for user query handling when a user is invited by a friend for lunch or a get-together, according to one or more embodiments disclosed herein; and

FIG. 9 illustrates an exemplary use case scenario for user query handling when inviting a service person for washing machine maintenance, according to one or more embodiments disclosed herein.

### DETAILED DESCRIPTION

For the purpose of promoting an understanding of the principles of the disclosure, reference will is made to the embodiments illustrated in the drawings and specific language may be used to describe the same. It is to nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates.

It is to understood by those skilled in the art that the foregoing general description and the following detailed description are explanatory of the disclosure and are not intended to be restrictive thereof.

Reference throughout the disclosure to “an aspect”, “another aspect” or similar language may refer to a particular feature, structure, or characteristic described in connection with an embodiment that may be included in at least one embodiment of the disclosure. Thus, appearances of the phrase “in an embodiment”, “in another embodiment”, and similar language throughout the disclosure may, but may not necessarily, refer to the same embodiment.

The terms “comprise”, “comprising”, or any other variations thereof, are intended to cover a non-exclusive inclusion, such that a process or method that comprises a list of operations may not include only those operations but may include other operations not expressly listed or inherent to such process or method. Similarly, one or more devices or sub-systems or elements or structures or components preceded by “comprises . . . a” may not, without more constraints, preclude the existence of other devices or other sub-systems or other elements or other structures or other components or additional devices or additional sub-systems or additional elements or additional structures or additional components.

The embodiments described herein and the various features and advantageous details thereof are explained more fully with reference to the non-limiting embodiments that are illustrated in the accompanying drawings and detailed in the following description. Descriptions of well-known components and processing techniques may be omitted so as to not unnecessarily obscure the embodiments herein. Also, the various embodiments described herein may not be necessarily mutually exclusive, as some embodiments may be combined with one or more other embodiments to form new embodiments. The term “or” as used herein, refers to a non-exclusive or unless otherwise indicated. The examples used herein are intended merely to facilitate an understanding of ways in which the embodiments herein may be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units or blocks or the like, or may include blocks or units, may be physically implemented by analog or digital circuits such as, but not limited to, logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Further, skilled artisans may appreciate that the elements in the drawings are illustrated for simplicity and may not have necessarily been drawn to scale. For example, the flow charts illustrate the method in terms of the most prominent operations involved to help improve understanding of aspects of the disclosure. Furthermore, in terms of the construction of the device, one or more components of the device may have been represented in the drawings by conventional symbols, and the drawings may show only those specific details that are pertinent to understanding the embodiments of the disclosure so as not to obscure the drawings with details that may be readily apparent to those of ordinary skill in the art having the benefit of the description herein.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Embodiments of the disclosure will be described below in detail with reference to the accompanying drawings.

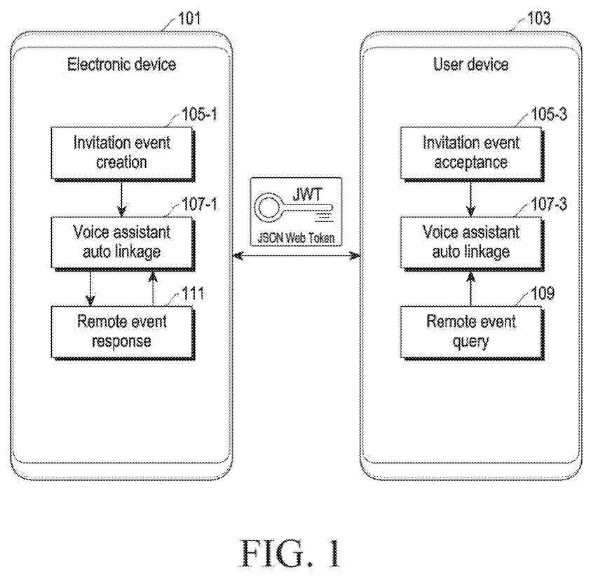

FIG. 1 illustrates a simplified flow diagram for temporal voice-based assistance for a remote event, according to one or more embodiments disclosed herein.

As illustrated in FIG. 1, the flow diagram includes interaction between an electronic device 101 and a user device 103. The electronic device 101 is associated with a host user and the user device 103 is associated with an invitee user. At operation 105-1, the host user creates an invitation for the remote event on the electronic device 101 and sends the invitation to the invitee user associated with the user device 103. In a non-limiting example, the host user may send the invitation via one of an application, a message, or a calendar invite. The electronic device 101 of the host user may be connected to a smart home environment associated with the remote event. At operation 105-3, the invitee user accepts the invitation event. Further, in operations 107-1 and 107-3, a voice assistant of the electronic device 101 is temporarily linked with a voice assistant of the user device 103 in a range of the remote event. In one or more examples, when the voice assistant of the electronic device 101 is temporarily linked with the voice assistance of the user device 103, the voice assistant of the user device 103 has limited access to the host user's smartphone data. For example, the voice assistant of the electronic device 101 and the user device 103 may be linked 1 hour before the invitation time and end when all guests leave after the event. Further, the voice assistant may be linked using a JWT-based certificate authentication to prevent an attack by a middleman. Further, at operation 109, when the invitee user sends any query for the remote event, the query is transferred to the remote event response module of the electronic device via the voice assistant of the electronic device 101 and the user device 103. The electronic device 101 may share the response to the query in natural language after privacy check and filtration format. The privacy check and filtration of the query may be performed to restrict the direct access of the data associated with the electronic device 101 or smart home data associated with the electronic device 101. For example, if a query would result in access to information that violates one or more privacy rules or policies, the query may be modified such that the modified query results in access to data that does not violate the privacy rules or policies. The response to the query is shared in natural language after the privacy check and the filtration of the query. Direct access to the smart home data is not provided to the invitee user. Therefore, with the JWT token, privacy check, and filtration of the query, the temporal voice-based assistance considers a three-pronged approach for privacy or security.

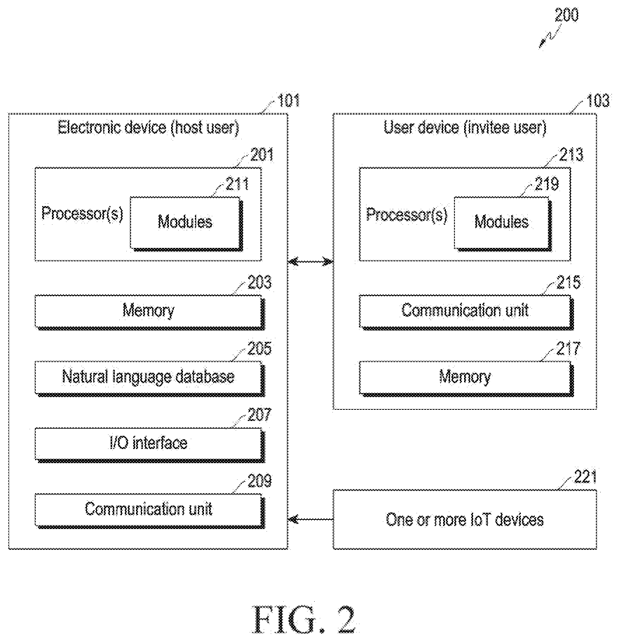

FIG. 2 illustrates a block diagram of a system 200 for temporal voice-based assistance for remote events, according to one or more embodiments disclosed herein.

The system 200 includes the electronic device 101 and the user device 103. The electronic device 101 includes at least one processor 201, memory 203, a natural language database 205, an input/output interface 207, and a communication unit 209.

The processor 201 may be operatively coupled to the modules 211 for processing, executing, or performing a set of operations. In another embodiment, the processor 201 may include at least one data processor for executing processes in a Virtual Storage Area Network. The processor 201 may include specialized processing units such as integrated system (bus) controllers, memory management control units, floating point units, graphics processing units, digital signal processing units, etc. In yet another embodiment, the processor 201 may include a central processing unit (CPU), a graphics processing unit (GPU), or both. The processor 201 may be one or more general processors, digital signal processors, application-specific integrated circuits, field-programmable gate arrays, servers, networks, digital circuits, analog circuits, combinations thereof, or other now known or later-developed devices for analyzing and processing data. The processor 201 may execute one or more instructions, such as code generated manually (i.e., programmed) to perform one or more operations disclosed herein throughout the disclosure.

In one or more embodiments, the processor 201 determines a location of the remote event, a start time, and an end time of the remote event. Further, the processor 201 monitors one or more ongoing activities within the smart environment in relation to the remote event. In one or more examples, the smart environment may be an assembly of sensors, actuators and many computational elements providing services for betterment of human life. The one or more ongoing activities are monitored via one or more IoT devices 221 present in the smart environment. Thereafter, the processor 201 stores information related to the monitored one or more ongoing activities in the natural language database 205 in a specified format.

Further, when the invitee user sends the query related to the remote event, the processor 201 receives the query and determines an access level of the invitee user to access the smart environment. Further, the processor 201 determines, using natural language database 205, a response to the received query based on the determined access level of the invitee user. Thereafter, the processor 201 transmits the determined response to the user device 103 associated with the invitee user.

In one or more embodiments, the processor 201 includes the modules 211 for performing specific operations. The term “module” or “modules” used herein may imply a unit including, for example, one of hardware, software, and firmware or a combination of two or more of them. The “module” or “modules” may be interchangeably used with a term such as logic, a logical block, a component, and the like. The “module” or “modules” may be a minimum device component for performing one or more functions or maybe a part thereof. The processor 201 may control the modules 211 to execute a specific set of operations described in the disclosure.

In one or more embodiments, the memory 203 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 203 is communicatively coupled with the processor 201 to store bitstreams or processing instructions for completing one or more processes. Further, the memory 203 includes an operating system for performing one or more tasks of the electronic device 101, as performed by a generic operating system in the communications domain.

In one or more embodiments, the natural language database 205 stores the information as required by the modules 211 and the processor 201 to perform one or more functions. Further, the natural language database 205 may store one or more values, such as, but not limited to, one or more intermediate data generated by the modules 211 and parameters required for the modules 211. The memory 203 may store one or more models for performing operations as disclosed throughout the disclosure. The natural language database 205 may also be referred to as “temporal natural language database” without departing from the scope of the disclosure.

In one or more embodiments, the I/O interface 207 refers to hardware or software components that enable communication between the electronic device 101 and the user device 103. The I/O interface 207 serves as a communication medium for exchanging information, commands, or query responses with other devices or systems. The I/O interface 207 may be a part of the processor 201 or maybe a separate component. The I/O interface 207 may be created in software or maybe a physical connection in hardware. The I/O interface 207 may be configured to connect with an external network, external media, the display, or any other components, or combinations thereof. The external network may be a physical connection, such as a wired Ethernet connection, or may be established wirelessly. In a non-limiting example, the electronic device 101 may be configured to communicate with the user device 103 via the I/O interface 207 to send the output of the query.

The communication unit 209 is configured to communicate voice, video, audio, images, or any other digital media content over a communication network. Further, the communication unit 209 may include a communication port or a communication interface for sending and receiving voice responses from the electronic device 101 via the communication network. The communication port or the communication interface may be a part of a processing unit or may be a separate component. The communication port may be created in software or may be a physical connection in hardware. The communication port may be configured to connect with the communication network, external media, the display unit, or any other components in the electronic device 101, or combinations thereof. The connection with the communication network may be a physical connection, such as a wired Ethernet connection, or may be established wirelessly as discussed above. Likewise, the additional connections with other components of the electronic device 101 may be physical or may be established wirelessly.

The user device 103 includes a processor 213, a communication unit 215, and a memory 217.

The processor 213 may be operatively coupled to the modules 219 for processing, executing, or performing a set of operations. In another embodiment, the processor 213 may include at least one data processor for executing processes in a Virtual Storage Area Network. The processor 213 may include specialized processing units such as integrated system (bus) controllers, memory management control units, floating point units, graphics processing units, digital signal processing units, etc. In yet another embodiment, the processor 213 may include a central processing unit (CPU), a graphics processing unit (GPU), or both. The processor 213 may be one or more general processors, digital signal processors, application-specific integrated circuits, field-programmable gate arrays, servers, networks, digital circuits, analog circuits, combinations thereof, or other now known or later developed devices for analyzing and processing data. The processor 213 may execute one or more instructions, such as code generated manually (i.e., programmed) to perform one or more operations associated with the user device 103 as disclosed herein throughout the disclosure.

In one or more embodiments, the processor 213 of the user device 103 sends a query to the electronic device 101. The processor 213 may also collect user attributes of the invitee user and send the collected attributes to the electronic device 101. The processor 201 of the electronic device 101 determines the intent of the invitee user and provides an authorization level to the invitee user based on the collected user attributes. The processor 213 may also receive the response of the query from the electronic device 101.

In one or more embodiments, the processor 213 includes the modules 219 for performing specific operations. The term “module” or “modules” used herein may imply a unit including, for example, one of hardware, software, and firmware or a combination of two or more of them. The “module” or “modules” may be interchangeably used with a term such as logic, a logical block, a component, and the like. The “module” or “modules” may be a minimum device component for performing one or more functions or maybe a part thereof. The processor 213 may control the modules 219 to execute a specific set of operations described in the disclosure.

The communication unit 215 is configured to communicate voice, video, audio, images, or any other digital media content over a communication network. Further, the communication unit 215 may include a communication port or a communication interface for sending and receiving voice responses from the user device 103 via the communication network. The communication port or the communication interface may be a part of a processing unit or may be a separate component. The communication port may be created in software or may be a physical connection in hardware. The communication port may be configured to connect with the communication network, external media, the display unit, or any other components in the user device 103, or combinations thereof. The connection with the communication network may be a physical connection, such as a wired Ethernet connection, or may be established wirelessly as discussed above. Likewise, the additional connections with other components of the user device 103 may be physical or may be established wirelessly.

In one or more embodiments, the memory 217 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes. The memory 217 is communicatively coupled with the processor 213 to store bitstreams or processing instructions for completing one or more processes. Further, the memory 217 includes an operating system for performing one or more tasks of the user device 103, as performed by a generic operating system in the communications domain.

The system also includes the one or more IoT devices 221. The one or more IoT devices 221 are associated with the smart environment of the host user. The one or more IoT devices may include one or more cameras of the smart environment, a motion sensor, a smart microwave device, a smart air conditioner system, a home speaker system, and other smart home devices.

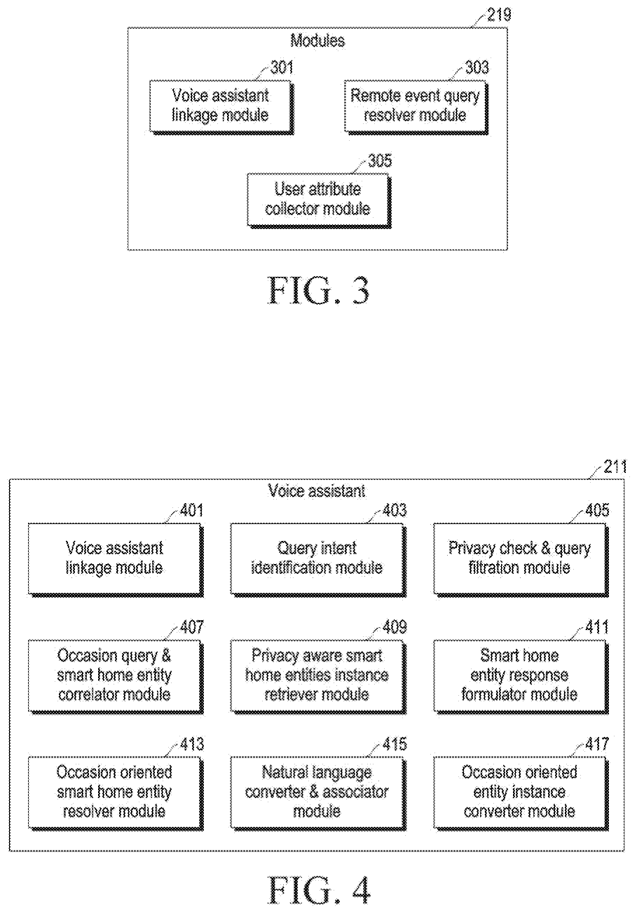

FIG. 3 illustrates a detailed block diagram of modules 219 of a user device 103 associated with the invitee user, according to one or more embodiments disclosed herein. The modules 219 include a voice assistant linkage module 301, a remote event query resolver module 303, and a user attribute collector module 305. As understood by one of the ordinary skill in the art, the modules illustrated in FIG. 3 may be performed by a processor such as processor 201 (FIG. 2). In one or more examples, each module may be implemented by individual circuitry.

The voice assistant linkage module 301 is configured to link the voice assistant of the user device 103 with the voice assistant of the electronic device 101 when the invitation of the remote event is received from the host user associated with the electronic device 101. The voice assistant linkage module 301 links the voice assistant of the user device 103 with the voice assistant of the electronic device 101 temporarily in the duration of the remote event.

The remote event query resolver module 303 receives the query related to the remote event from the invitee user. The remote event query resolver module 303 may determine the instances in spoken commands that refer to the remote event or remote occasion. The remote event query resolver module 303 sends the query to the electronic device 101.

The user attribute collector module 305 collects the attribute of the invitee user and the context to which the invitee user might be referring to when the query was spoken. The user attribute collector module 305 sends the collected attribute and the contexts to the electronic device 101. The collected attribute may include information that the invitee user is invited to the remote event, the context associated with the remote event and the invitee user, information whether the host user is part of a contact list of the invitee user, information related to a past communication between the invitee user and the host user, information related to previously used voice-based assistance communication of the invitee user, and an action of the invitee user corresponding to the remote event.

The remote event query resolver module 303 also receives the response to the query from the electronic device 101 and provides an output to the invitee user in the form of a voice response.

FIG. 4 illustrates a detailed block diagram of modules 211 of the electronic device 101 associated with the host user, according to one or more embodiments disclosed herein.

The modules 211 includes a voice assistant linkage module 401, a query intent identification module 403, a privacy check & query filtration module 405, an occasion query & smart home entity correlator module 407, a privacy-aware smart home entities instance retriever module 409, a smart home entity response formulator module 411, an occasion oriented smart home entity resolver module 413, a natural language converter & associator module 415, and an occasion oriented entity instance converter module 417.

The voice assistant linkage module 401 is configured to link the voice assistant of the electronic device 101 with the voice assistant of the user device 103 when the invitation of the remote event is accepted at the user device 103. The voice assistant linkage module 301 links the voice assistants temporarily in the duration of the remote event. The voice assistant linkage module 301 facilitates the inter-voice assistant communication between the electronic device 101 and the user device 103.

The query intent identification module 403 is configured to receive the query from the invitee user and also receives the attribute of the invitee user and the context to which the invitee user might be referring to when the query was spoken. The attribute of the invitee user may include the information that the invitee user is invited to the remote event, the context associated with the remote event and the invitee user, information whether the host user is part of the contact list of the invitee user, information related to the past communication between the invitee user and the host user, information related to previously used voice-based assistance communication of the invitee user, and the action of the invitee user corresponding to the remote event. In a non-limiting example, the action of the invitee user corresponding to the remote event may include the invitee user's action of setting the location map of the remote event while driving towards the remote location.

The query intent identification module 403 is further configured to determine the authorization level provided to the invitee user based on the received attribute of the invitee user. The query intent identification module 403 is further configured to determine an access level for all invitee users based on the determined authorization level. The query intent identification module 403 further manages an access control database indicating the access level for all invitee users.

The privacy check & query filtration module 405 is configured to determine an intent of the invitee user based on a determination that the invitee user is invited to the remote event, the action of the invitee user corresponding to the remote event, and a degree of association of the received query with the remote event. For instance, the privacy check & query filtration module 405 checks and filters the queries that will intrude privacy. The privacy check & query filtration module 405 determines the degree of association of the received query with the remote event and filters the received query in a case when the determined degree of association indicates that the received query is unrelated to the remote event.

In one or more embodiments, the privacy check & query filtration module 405 filters the query if the query is not related to the remote event, the query is related to a person's presence, the query is related to any security devices or any security sensors, the query is related to the location of devices and persons, the query is related to voice assistance application, or the query is related to home security and privacy. In a non-limiting example, the privacy check & query filtration module 405 filters the query if the query is related to the home security (for example lock code of the door) or the privacy of the user (camera stream).

The privacy check & query filtration module 405 is configured to provide access on a subset of data with the smart environment to the invitee user based on the determined intent of the invitee user and the determined access level of the invitee user. The privacy check & query filtration module 405 outputs the filtered query to the occasion query & smart home entity correlator module 407.

The occasion query & smart home entity correlator module 407 is configured to retrieve the smart home entities such as objects and activities in the smart environment that is relevant to the current query and the event. The occasion query & smart home entity correlator module 407 expands the query and co-relates the query with the smart home entities such as the objects and the activities. The occasion query & smart home entity correlator module 407 further score all the recognized smart home entities based on the query and the context of the invitee user. The instances that will be part of the final response are based on a correlation index or the score.

Further, the privacy-aware smart home entities instance retriever module 409 is configured to retrieve one or more instances of the activities that are correlated with the received query. The one or more instances of the activities are retrieved from natural language database 205 based on the query and the access level of the invitee user.

The smart home entity response formulator module 411 is configured to determine the response to the received query based on the retrieved one or more instances. The smart home entity response formulator module 411 further transmits the determined response to the user device 103 associated with the invitee user.

The occasion oriented smart home entity resolver module 413 is configured to track smart home entities (objects and activities in the smart environment) that have relevance with the invited event/occasion. The occasion oriented smart home entity resolver module 413 determines if the tracked entities may be converted in the user's natural language (NL) usage from a history of the user's interaction. The occasion oriented smart home entity resolver module 413 further gives NL word-entity relevance score to the tracked entities. The occasion oriented smart home entity resolver module 413 further filters and prioritizes the activities.

The natural language converter & associator module 415 is configured to add NL relevance to the tracked entities having relevance with the invited event. The natural language converter & associator module 415 further converts all the associated smart home data to the entity to a semantic database which may be used to further generate responses in natural language processing (NLP). The natural language converter & associator module 415 helps to decide the optimal response for the user query.

The occasion oriented entity instance converter module 417 adds relevant parameters to the tracked entities for further querying and instance additions. The smart home entities linked with NL space are passed on to the occasion oriented entity instance converter module 417 to be converted into smart home instances for storage and future NLP context. These smart home instances are retrieved from the natural language database 205 based on the query and expanded invitee query. The occasion oriented entity instance converter module 417 uses a semantic model to add relevant parameters to the tracked entities. In a non-limiting example, the semantic model may be a keyword to sentence generation model.

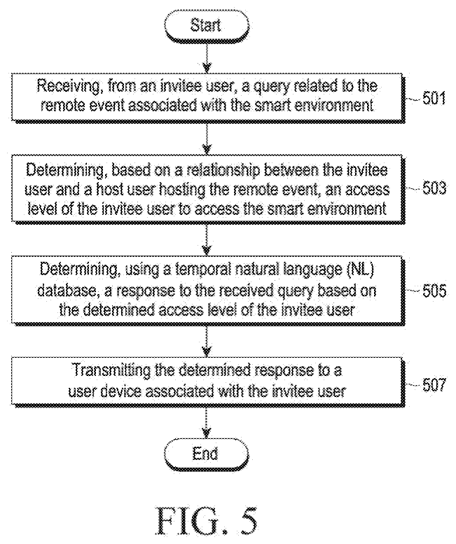

FIG. 5 illustrates a flow chart of a method 500 for performing temporal voice-based assistance for the remote event associated with a smart environment, according to one or more embodiments disclosed herein. The method 500 includes a series of operations 501 through 507 performed by the processor 201 of the electronic device 101.

At operation 501, the processor 201 receives, from the invitee user, the query related to the remote event associated with the smart environment. The flow of the method 500 now proceeds to operation 503.

At operation 503, the processor 201 determines the access level of the invitee user to access the smart environment based on a relationship between the invitee user and the host user hosting the remote event. For instance, the processor 201 may determine the relationship between the invitee user and the host user based on the attribute of the invitee user and the context to which the invitee user might be referring to when the query was spoken. The processor 201 may also store access levels for all invitee users in the access control database. The flow of the method 500 now proceeds to operation 505.

At operation 505, the processor 201 determines, using the natural language database 205, the response to the received query based on the determined access level of the invitee user, for instance, the processor 201 may correlate the received query with the one or more ongoing activities. The processor 201 may further retrieve, from the natural language database 205, one or more instances of the one or more ongoing activities that are correlated with the received query. Thereafter, the processor 201 may determine the response to the received query based on the retrieved one or more instances. The flow of the method 500 now proceeds to operation 507.

At operation 507, the processor 201 transmits the determined response to the user device 103 associated with the invitee user.

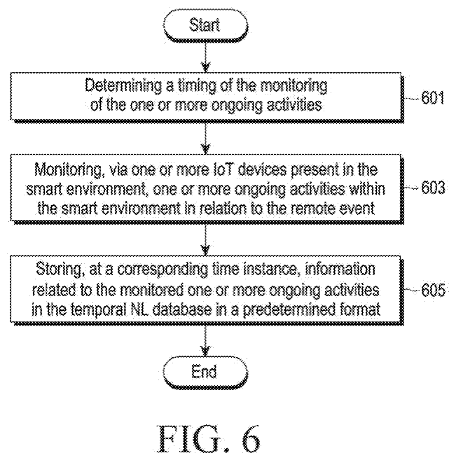

FIG. 6 illustrates a flow chart 600 of a method for storing information related to one or more ongoing activities in the natural language database 205, according to one or more embodiments disclosed herein. The method 600 includes a series of operations (e.g., operations 601 through 605) performed by the processor 201 of the electronic device 101.

At operation 601, the processor 201 determines the timing of the monitoring of the one or more ongoing activities. The processor 201 may determine the start time and the end time of monitoring of the one or more ongoing activities. The processor 201 may determine the start time and the end time based on the information associated with the invitation of the remote event. The flow of the method 600 now proceeds to operation 603.

At operation 603, the processor 201 monitors, via the one or more IoT devices present in the smart environment, the one or more ongoing activities within the smart environment in relation to the remote event. More preferably, the processor 201 may track smart home entities such as one or more objects and the one or more ongoing activities in the smart environment. The processor 201 may convert the smart home entities which are related to the event into the user's NL space and add relevant parameters for further querying and instance additions. The flow of the method 600 now proceeds to operation 605.

At operation 605, the processor 201 stores, at a corresponding time instance, information related to the one or more ongoing activities in the natural language database 205 in a specified format, for instance, the processor converts the one or more ongoing activities in the natural language database 205 into smart home instances and stores the smart home instances in the natural language database 205. These smart home instances are retrieved from the natural language database 205 based on the query and expanded invitee query.

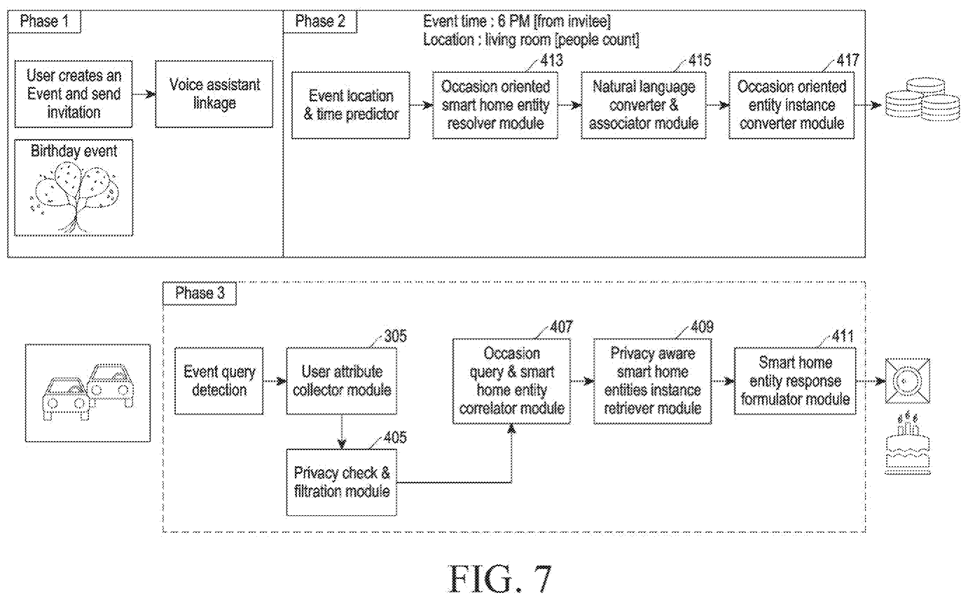

FIG. 7 illustrates an exemplary use case scenario for user query handling when a user is invited to a birthday party, according to one or more embodiments disclosed herein.

In the exemplary use case scenario, the user query handling is performed in three phases. In a first phase, the host user creates an invitation to the birthday party event and sends the invitation to the invitee user. Next, when the invitee user accepts the invitation to the birthday party event, the voice assistant of the electronic device 101 (host user's device) will be linked temporarily with the voice assistant of the user device 103 (invitee user's device) in a range of the birthday party event. In one or more examples, the range may refer to a location (e.g., within a predetermined distance of the event) and/or timing (e.g., within a predetermined time of the event).

In a second phase, also called a pre-learning phase, the electronic device 101 of the host user performs the following operations. At a first operation of the second phase, the electronic device 101 determines the timing of the monitoring of the one or more ongoing activities in the birthday party event. The electronic device 101 may determine the start time and the end time of the birthday party event and the birthday party event location using a rule-based AI Model.

At a second operation of the second phase, the occasion oriented smart home entity resolver module 413 tracks the smart home entities (objects and activities in the smart environment) that have relevance to the birthday party event. In a non-limiting example, the tracked smart home entities may be given as shown in Table 1 below.

TABLE 1

| Smart Home | | Device | |
|---|---|---|---|
| Entity | IoT Device | Interaction | Assoc. Parameters |
| Cake | Family Hub | Remove | Time: 6:55 PM, Size: |
| | | | 10 Kg |
| Guest | Camera/Speaker/ | >5 | Time: 7:00 PM |
| | UWB | | |
| Song Playing | Speaker | BTS | Volume −85, High |
| | | | Brass |
| Door | Motion Sensor | Opening | x, y, 5 seconds |
| Food | Microwave Oven | Grill | Grill started 3 minutes |
| preparation | | {Mushroom] | back |
| User | AC, Air Purifier | ON from last | Outside temp: 30'C, |
| convenience | on [3 TPM] | 20 mins | Pollution level: Very |
| | | | High |

A third operation of the second phase, the natural language converter & associator module 415, adds the NL relevance to the tracked entities that have the relevance with the birthday party event. In a non-limited example, the added NL relevance to the tracked entities may be given as shown in Table 2 below.

TABLE 2

| NL Focus Point | Past Query Type | Status |
|---|---|---|
| Cake | Cake Cutting | ~5 mins |
| Party Location | Where is the Party | Indoor/Outdoor/ |
| | | Location |
| Guest | #oF guests /Adults/Kids | 5/3 |
| Food Preparation | Food orders, preparation | Started |
| Food and drinks serving | Started /In progress /End | Not Stated |
| Light Setting | 5 Lights ON | Party mode: ON |

At a fourth operation of the second phase, the occasion oriented entity instance converter module 417 converts the smart home entities linked with NL space into smart home instances for storage and future NLP context. The occasion oriented entity instance converter module 417 adds relevant parameters to the tracked entities for further querying and instance additions. In a non-limited example, the smart home entities converted into smart home instances may be given as shown in Table 3 below, where L-01 to L-10 indicate the level of authorization.

TABLE 3

| | Query | Access Control: Invitee/ |
|---|---|---|
| Entity | Keywords \| Instances | Host Co-relationship |
| Occasion | Birth Day of John | Authority: All Invitees [L-0] |
| People Invited | 20 | Authority: All Invitees[L-0] |
| Current Time | 07:00:01PM | Authority: NA |
| Party Location | Indoor/Living Room | Authority: All users contacted |
| | | via messaging/Phone |
| | | app [L-3] |
| AC/Air Purifier | Outside temp: 30'C, | Authority: Only |
| | Pollution level: | for all contacts |
| | Very High Hall | from the Phone app [L-3] |
| | temp: 23'C Air | |
| | Purifier: ON | |
| Guest | 5 Adults/ 3 Kids | Authority: Only Previous |
| | | invited users[L-10] |
| Food Serving | Not started | Authority; All Invitees |
| status | | [L = 0] |

In a third phase, the user query handling is performed. At a first operation of the third phase, the event query detection is performed when the invitee user asks a query related to the birthday party event. In a non-limiting example, the invitee user may ask “whether the birthday party event is pet friendly”, “if the cake cutting is completed”, “if the birthday party is an outdoor party”, “if the birthday party has started, what is the temperature inside the party hall”, or “how many people are there in the birthday party”. The event query detector determines the instances in the spoken command that refer to the birthday party event. In a non-limited example, the query event detected may be given as shown in Table 4 below.

TABLE 4

| Query param | Smart Home Entity Type | Description |
|---|---|---|
| Occasion | Person | Birth Day of John |
| Cake | Cake Cutting | Time associated |
| Location | Indoor/Outdoor | Party location |
| Guest | Guest type | Adult/Kids |

At a second operation of the third phase, the user attribute and related context are collected. In a non-limited example, the collected user attribute may be given as shown in Table 5 below.

TABLE 5

| Category | Description | Assoc. params |
|---|---|---|
| Invitee Location: | 3 Km from the party, | Need 20 mins |
| 35^{th} Street | Heavy traffic | to reach the |
| | | Party |
| Relation | Friend of The Organizer | Meets once a week, |
| | | Invited to location |
| Security Token | Oxgfthegrbhrgvrbryrb | JWT Token for access |

At a third operation of the third phase, the privacy check & query filtration module 405 determines an access level for the invitee user based on the event/people index co-relationship. Further, the privacy check & query filtration module 405 filters the questions related to home security and privacy intrusion. The privacy check & query filtration module 405 outputs the filtered query to the occasion query & smart home entity correlator module 407.

At a fourth operation of the third phase, the occasion query & smart home entity correlator module 407 expands the query and associates the query with the smart home entities such as the objects and the activities. In a non-limited example, the co-related query may be given as shown in Table 6 below.

TABLE 6

| | Smart Home Related | |
|---|---|---|
| Query Part | Entity | Action/Relation |
| Occasion | Person | Birth Day of John |
| Cake | Cake Removed from a | Time associated |
| | Family hub | |
| Location | Indoor/Outdoor | Party location |
| Guest | Invited/Attended | 25/12 |

At a fifth operation of the third phase, the privacy-aware smart home entities instance retriever module 409 is configured to retrieve one or more instances of the activities that are correlated with the received query. The one or more instances of the activities are retrieved from natural language database 205 based on the query and the access level of the invitee user. In a non-limited example, the retrieved one or more instances of the activities may be given as shown in Table 7 below.

TABLE 7

| | | | Access |
|---|---|---|---|
| | | | Control/ |
| NLP Entity | Instance Params | Time | Authorization |
| Cake | Removed From Fridge | 7:01 PM | L-03 |
| Arrangement | Cake Cutting in | 7:15 PM\| predicted | L-07 |
| | a living room | | |
| Food | Not served yet | Interaction Type | L-01 |
| Door | Door open | 09:15; Nine times | L-10 |
| Location | Indoor Party | Outdoor for Playing | L-03 |

At a sixth operation of the third phase, the smart home entity response formulator module 411 determines the response to the received query based on the retrieved one or more instances. Further, the smart home entity response formulator module 411 provides the response to the invitee user. In a non-limiting example, the response to the received query may be a phrase saying “Hurry up! Cake was removed from the fridge in last 2 mins! It may be anytime from now”, “it is an indoor party”, “Air quality is around is 250 PM and Temperature is 24′c”, or “Hurry up party has started and 3 People have arrived already”. In another non-limiting example, the response to the received query may be a phrase saying “Sorry! I cannot answer this” in a case if the invitee user does not have an access level for the specific query.

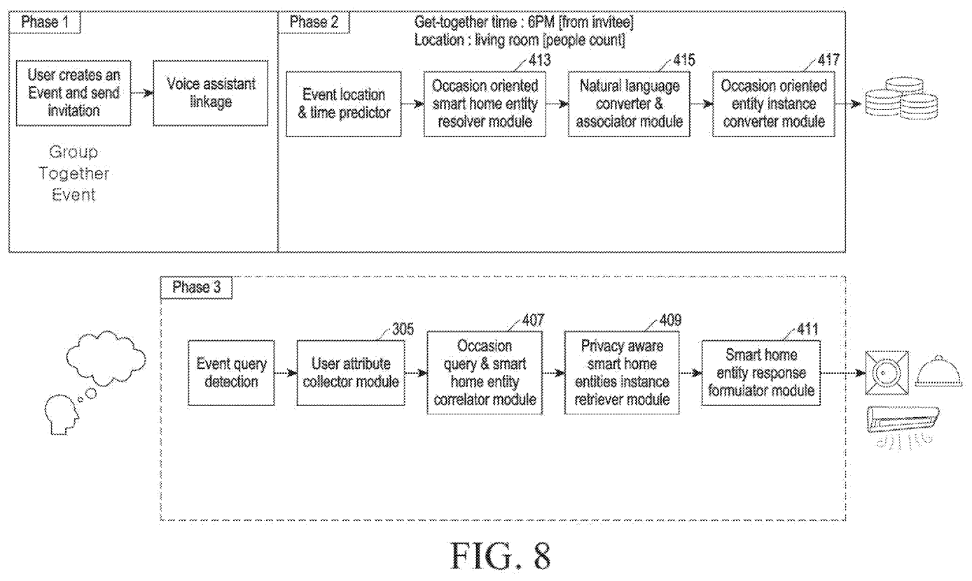

FIG. 8 illustrates an exemplary use case scenario for user query handling when the user is invited by a friend for lunch or a get-together, according to one or more embodiments disclosed herein.

In the exemplary use case scenario, the user query handling is performed in three phases. In a first phase, firstly the host user creates an invitation for a lunch or get-together and sends the invitation to the invitee user. Next, when the invitee user accepts the invitation, the voice assistant of the electronic device 101 (host user's device) will be temporarily linked with the voice assistant of the user device 103 (invitee user's device) in a range of the lunch or get-together event.

In a second phase, also called the pre-learning phase, the electronic device 101 of the host user performs the following operations. At a first operation of the second phase, the electronic device 101 determines the timing of the monitoring of the one or more ongoing activities in the lunch or get-together event. The electronic device 101 may determine the start time and the end time of the lunch or get-together event and the event location using the rule-based AI model.

At a second operation of the second phase, the occasion oriented smart home entity resolver module 413 tracks the entities (objects and activities in the smart environment) that have relevance to the lunch or get-together event. In a non-limited example, the tracked smart home entities may be given as shown in Table 8 below.

TABLE 8

| Smart Home | | Device | |
|---|---|---|---|
| Entity | IoT Device | Interaction | Assoc. params |
| Things/Gifts | UWB, | Scan things/ | Kitchen: Wine |
| | Camera | materials | Glasses, etc |
| | | in home | Hallway: |
| | | | Paintings, Books |
| Food | Oven, Fridge, | Scan available | Oven: Cake |
| | UWB, | drinks/food, Grill | Fridge: Wine, Juices |
| | Air fryer | (Mushroom], | Grill started 3 |
| | | Potato | minutes back, Steak |
| | | Fries, Steak | cooking level |
| Smart home | Icemaker, | Adjusting setting | Icemaker status |
| setting | AC, Purifier, | | (no ice), |
| | Fridge | | AC (25 deg.), |
| | | | Purifier 60 |
| | | | AQI, Fridge |
| | | | Temp (5 deg.) |
| User | AC, Air | Status (ON) | Outside temp: |
| Preferences | Purifier | Duration | 30'C, Home |
| | on [3 PM], | (5 Hrs) | AQI, Ice Making |
| | Ice Maker | | frequency |

At a third operation of the second phase, the natural language converter & associator module 415 adds the NL relevance to the tracked entities that have the relevance with the lunch or get-together event. In a non-limited example, the added NL relevance to the tracked entities may be given as shown in Table 9 below.

TABLE 9

| NL Focus Point | Past Query Type | Status |
|---|---|---|
| Food | Foods prepared, What | Drinks, Juices, |
| | should be bought | etc. |
| Gifts/Souvenirs | Things are already | Paintings, |
| | there at home. | Chocolates |
| | Privacy awareness | or wine |
| Guest | #of guests/Adults/Kids | 5/3 |
| Smart home setting | Icemaker, AC, Purifier | Icemaker: On |
| | Setting | AC: 25 degree |
| | | Purifier 60 AQI |

At a fourth operation of the second phase, the occasion oriented entity instance converter module 417 converts the tracked entities linked with NL space into smart home instances for storage and future NLP context. The occasion oriented entity instance converter module 417 adds relevant parameters to the tracked entities for further querying and instance additions. In a non-limited example, the tracked entities converted into smart home instances may be given as shown in Table 10 below.

TABLE 10

| | |
|---|---|
| Entity | Query Keywords \| Instances |
| Occasion | Friends Get-Together |
| People Invited | 10 |
| Current Time | 07:00:01 PM |
| Location | Indoor/Living Room |
| AC, Air Purifier, | Room Temp: 25debAQI: |
| Ice Maker | 60Ice Maker: ON |
| Foods served | Suitable for user health preference |
| Gifts | Gifts, Food suggestions |

In a third phase, the user query handling is performed. At a first operation of the third phase, the event query detection is performed when the invitee user asks a query related to the lunch or get-together event. In a non-limiting example, the invitee user may ask “Can I get some wine for today's get-together”, “Is food preparation started? What's cooking for today's get-together”, “Do I have a vegan Option Today?”, “how is the home/room temperature and air quality, I feel repulsive to coldness today, will it suit me”, “Can you adjust room/food temperature suitable for me”, “Can you prepare more ice cubes.”, or “Can I buy wall painting or frame for today's Get together?”.

The event query detector determines the instances in spoken command that refer to the lunch or get-together event. In a non-limited example, the query event detected may be given as shown in Table 11 below.

TABLE 11

| Query parameter | Smart Home Entity Type | Description |
|---|---|---|
| Occasion | Family & Friends | Get-together |
| Food | Lunch | Food and time associated |
| Health | Smart devices | Inviter's smart home state |
| | (AC/Purifier/Fridge) | |
| Preferences | Smart devices | Inviter's smart home state |
| Gifts | Rooms & things | Things present |

At a second operation of the third phase, the user attribute and related context are collected. In a non-limited example, the collected user attribute may be given as shown in Table 12 below.

TABLE 12

| Category | Description | Assoc. para. |
|---|---|---|
| Relation | Friend of The | Meets once a week, Invited |
| | Organizer | to get-together |
| Security Token | Oxgfthegrbhrgvrbryrb | JWT Token for access |
| Preferences | Health and personal | Preferred Temp, AQI, |
| | preferences | Food Serving |

At a third operation of the third phase, the occasion query & smart home entity correlator module 407 expands the query and associates the query with the entities such as the objects and the activities. In a non-limited example, the co-related query may be given as shown in Table 13 below.

TABLE 13

| Query Part | Smart Home Related Entity | Action/Relation |
|---|---|---|
| Occasion | Get-together | Catch-up of friends |
| Gifts/Souvenirs | Things & Food | Things that are |
| | | available in the |
| | | inviter's home. |
| Smart home | AC Temp, Purifier, | Get/Apply attributes |
| setting | Ice Maker | based on |
| | | preference |
| Guest | Invited | 10 |

At a fourth operation of the third phase, the privacy-aware smart home entities instance retriever module 409 is configured to retrieve one or more instances of the activities that are correlated with the received query. The one or more instances of the activities are retrieved from natural language database 205 based on the query, the access level of the invitee user, and the privacy check and the filtration of the query. In a non-limited example, the retrieved one or more instances of the activities may be given as shown in Table 14 below.

TABLE 14

| NLP Entity | Instance Params | Privacy-aware actions |
|---|---|---|
| Entities | Gift-able entities | Scan-able areas in the home |
| | the inviter has. | |
| Smart home | Preferred setting | Adjustable/overridable |
| setting | for invitees | smart settings |
| Food | Serving Method/ | Food serving predicted |
| | Category | conditions during the event |
| Door | Door open | 09:15; Nine times |
| Kitchen | Food currently prepared | Suggestions to buy new food |

At a fifth operation of the third phase, the smart home entity response formulator module 411 determines the response to the received query based on the retrieved one or more instances. Further, the smart home entity response formulator module 411 provides the response to the invitee user. In a non-limiting example, the response to the received query may be a phrase saying “You can go for some chocolates, blueberry wine”, “You better go for a painting”, “Room temp is 25 deg, AQI is 60. Do you have any preferences?”, or “Food would be served hot with some cold juice, what's your preference?”.

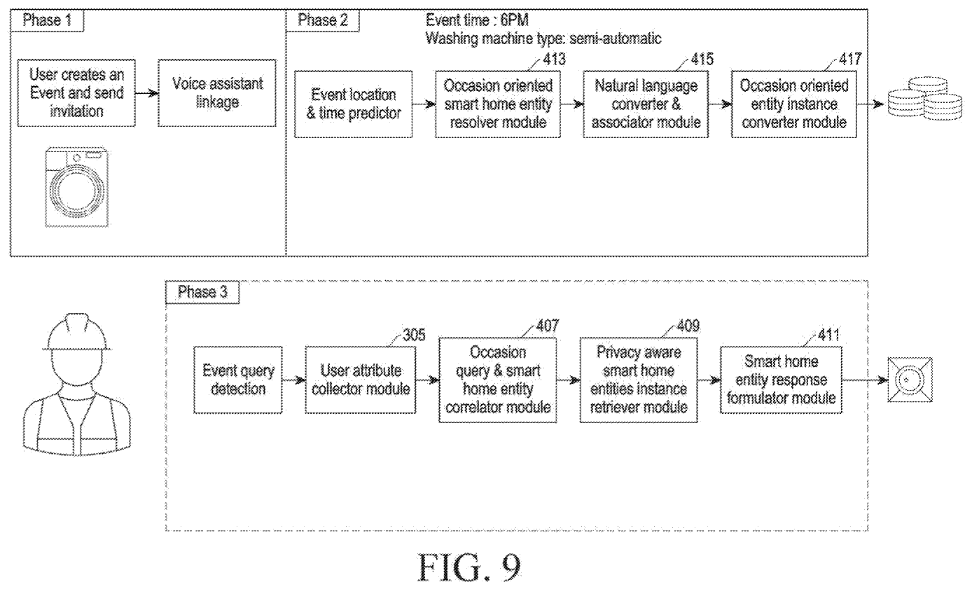

FIG. 9 illustrates an exemplary use case scenario for user query handling when inviting a service person for washing machine maintenance, according to one or more embodiments disclosed herein.

In the exemplary use case scenario, the user query handling is performed in three phases. In the first phase, firstly the host user creates an event for the washing machine maintenance and invites the service person. Next, when the service person accepts the invitation, the voice assistant of the electronic device 101 (host user's device) will be temporarily linked with the voice assistant of the user device 103 (service person's device) in a range of the event.

In a second phase, also called the pre-learning phase, the electronic device 101 of the host user performs the following operations. At a first operation of the second phase, the electronic device 101 determines the timing of the monitoring of the status of the event appliance (washing machine). The electronic device 101 may determine the event time and event appliance type (e.g., semi-automatic washing machine).

At a second operation of the second phase, the occasion oriented smart home entity resolver module 413 tracks the entities (objects and activities in the smart environment) that have relevance to the washing machine maintenance event. In a non-limited example, the tracked smart home entities may be given as shown in Table 15 below.

TABLE 15

| SmartHome | | Device | |
|---|---|---|---|
| Entity | IOT Device | Interaction | Assoc. params |
| Electrician | Camera/speaker/UWB | >5 | Time: 6:55 PM |
| Electric | Washing machine | >=1 | Type = semi- |
| Appliance | | | automatic, |
| | | | capacity = 8 kg |
| washer | Rotor position sensor, | Rotor, | working (yes/No), |
| | water level sensor, Dirt | washing | Physical |
| | sensor, pressure sensor, | cloth | Damage(Yes/No) |
| | Vibration sensor, camera | | |
| dryer | Temperature sensor, | Drying cloth | working (yes/No), |
| | water level sensor, Dirt | | Physical |
| | sensor, pressure sensor, | | Damage(Yes/No) |
| | Vibration sensor, camera | | |
| User | Speaker, light, | Washer/dryer | Notification |
| convenience | camera, | timer | available |
| | family hub | notification | (yes/no) |

At a third operation of the second phase, the natural language converter & associator module 415 adds the NL relevance to the tracked entities that have the relevance with the status of the washing machine for the washing machine maintenance event. In a non-limited example, the added NL relevance to the tracked entities may be given as shown in Table 16 below.

TABLE 16

| NL Focus Point | Past Query Type | Status |
|---|---|---|
| washer | i. Rotor rotating | i. Yes |
| | ii. Leaking | ii. No |
| | iii. Too noisy | iii. Yes |
| | iv. Dirty | iv. No |
| dryer | i. Rotor spinning | i. No |
| | ii. Too noisy | ii. No |
| | iii. dirty | iii. No |
| alarm | Buzzing | 3 times |
| Power Cable | Connected | yes |
| power | Available | yes |

At a fourth operation of the second phase, the occasion oriented entity instance converter module 417 converts the tracked entities linked with NL space into smart home instances for storage and future NLP context. The occasion oriented entity instance converter module 417 adds relevant parameters to the tracked entities for further querying and instance additions. In a non-limited example, the tracked entities converted into smart home instances may be given as shown in Table 17 below.

TABLE 17

| Entity | Query Keywords \| Instances |
|---|---|
| Occasion | Washing machine maintenance |
| electrician arriving time | 7:00 pm |
| electricity status | available |
| Washing machine type | Automatic/semi-automatic |

In a third phase, the user query handling is performed. At a first operation of the third phase, event query detection is performed when the service person asks a query related to the status of the washing machine for the washing machine maintenance event. In a non-limiting example, the service person may ask “Is the washing machine working?”, “Is the dryer too noisy?”, “Is the rotor working?”, or “Is the alarm working?”

The event query detector determines the instances in spoken commands that refer to the washing machine maintenance event. In a non-limited example, the query event detected may be given as shown in Table 18 below.

TABLE 18

| Query parameter | Smart Home Entity Type | Description |
|---|---|---|
| Occasion | Washing machine | Washing machine |
| | | maintenance |
| power | On/off | Cable connected |
| washer | Working status | Rotor working, no leakage |
| dryer | Working status | Spinner working |

At a second operation of the third phase, the user attribute and related context are collected. In a non-limited example, the collected user attribute may be given as shown in Table 19 below.

TABLE 19

| Category | Description | Assoc. parameters |
|---|---|---|
| Washing machine | Automatic/ | Top load, front load, capacity |
| type | semi-automatic | |
| Relation | Electrician | Washing machine maintenance |
| Security Token | Oxgfthegrbhrgvrbryrb | JWT Token for accesss |

At a third operation of the third phase, the occasion query & smart home entity correlator module 407 expands the query and associates the query with the entities. In a non-limited example, the co-related query may be given as shown in Table 20 below.

TABLE 20

| Query Part | Smart Home Related Entity | Action/Relation |
|---|---|---|
| Occasion | Washing machine | maintenance |
| power | Sensors working | Cable connected |
| washer | Working status | Detect leakage, rotor |
| | | status, noise, extra dirt |
| dryer | Working status | Detect rotor status, noise |

At a fourth operation of the third phase, the privacy-aware smart home entities instance retriever module 409 is configured to retrieve one or more instances of the status of the washing machine that are correlated with the received query. The one or more instances of the status are retrieved from natural language database 205 based on the query, the privacy check and the filtration of the query, and the access level of the invitee user. In a non-limited example, the retrieved one or more instances of the status may be given as shown in Table 21 below.

TABLE 21

| NLP Entity | Instance Params | status |
|---|---|---|
| dryer | Rotor status, noise level | noisy |
| Washer | Rotor status, dirt check, water | Working fine |
| | lever, noise check | |
| power | Cable connected | on |

At a fifth operation of the third phase, the smart home entity response formulator module 411 determines the response to the received query based on the retrieved one or more instances of the status of the washing machine. Further, the smart home entity response formulator module 411 provides the response to the user. In a non-limiting example, the response to the received query may be a phrase saying “cable is connected”, “dryer is too noisy” or “rotor is working”.

In an example, the module(s) and/or the unit(s) and/or model(s) may include a program, a subroutine, a portion of a program, a software component, or a hardware component capable of performing a stated task or function. As used herein, the module(s) and/or the unit(s) and/or model(s) may be implemented on a hardware component such as a server independently of other modules, or a module may exist with other modules on the same server, or within the same program. The module(s) and/or unit(s) and/or model(s) may be implemented on a hardware component such as processor one or more microprocessors, microcomputers, microcontrollers, digital signal processors, central processing units, state machines, logic circuitries, and/or any devices that manipulate signals based on operational instructions. The module(s) and/or unit(s) and/or model(s), when executed by the processor(s), may be configured to perform any of the described functionalities.

The method disclosed herein in one or more embodiments provides various technical benefits and advantages. The method and system as disclosed herein help to implement key use cases for remote smart home-based voice interactions. The method facilitates the implementation of various use case scenarios where smart home data is needed by various users who are invited to the remote event associated with the smart home environment. Also, the method disclosed herein provides a seamless natural remote interaction and privacy-aware temporal access for smart home events.

Further, the disclosed method provides a methodology to secure the privacy of the host user. The disclosed method helps in filtering the query if the query is unrelated to the remote event. In a non-limiting example, the above-disclosed method may filter the query if the query is related to the home security (for example lock code of the door) or the privacy of the user (camera stream).

The various actions, acts, blocks, operations, or the like in the flow diagrams may be performed in the order presented, in a different order, or simultaneously. Further, in some embodiments, some of the actions, acts, blocks, operations, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for performing voice-based assistance by a first electronic device associated with a host user, the method comprising:
receiving, from a second electronic device associated with an invitee user, a query related to a remote event associated with a smart environment;
determining, based on information on the invitee user and the host user hosting the remote event, an access level of the invitee user to access the smart environment; and
transmitting, using a natural language (NL) database, a response to the received query to the second electronic device based on the determined access level of the invitee user.

2. The method of claim 1, further comprising:
determining an intent of the invitee user based on at least one of (i) a determination that the invitee user is invited to the remote event, (ii) an action of the invitee user corresponding to the remote event, or (iii) a degree of association of the received query with the remote event; and
providing, based on the determined intent of the invitee user and the determined access level of the invitee user, an access to data associated with the smart environment to the second electronic device.

3. The method of claim 1, wherein the information on the invitee user and the host user is based on at least one of (i) a determination that the host user is included in a contact list of the invitee user, (ii) information related to a past communication between the invitee user and the host user, (iii) previously used voice-based assistance communication of the invitee user, or (iv) one or more contexts associated with the remote event.

4. The method of claim 1, further comprising:
monitoring, via one or more IoT devices in the smart environment, one or more ongoing activities within the smart environment in relation to the remote event; and
storing, at a time instance corresponding to the remote event, information related to the monitored one or more ongoing activities in the NL database in a specified format.

5. The method of claim 4, wherein the information related to the monitored one or more ongoing activities is stored in the NL database for a duration until a completion of the remote event.

6. The method of claim 4, wherein a timing of the monitoring of the one or more ongoing activities is based on at least one of a start time of the remote event, an end time of the remote event, or a relation of the one or more ongoing activities.

7. The method of claim 4, further comprising:
correlating the received query with the one or more ongoing activities;
retrieving, from the NL database, one or more instances of the one or more activities that are correlated with the received query; and
determining the response to the received query based on the retrieved one or more instances.

8. A first electronic device for performing voice-based assistance, the electronic device comprising:
a natural language (NL) database;
at least one processor including processing circuitry; and
memory storing instructions that, when executed by the at least one processor individually or collectively, cause the first electronic device to:
receive, from a second electronic device associated with an invitee user, a query related to a remote event associated with a smart environment;
determine, based on information on the invitee user and a host user hosting the remote event, an access level of the invitee user to access the smart environment; and
transmit, using the NL database, a response to the received query to the second electronic device based on the determined access level of the invitee user.

9. The first electronic device of claim 8, wherein the instructions, when executed by the at least one processor individually or collectively, further cause the first electronic device to:
determine an intent of the invitee user based on at least one of (i) a determination that the invitee user is invited to the remote event, (ii) an action of the invitee user corresponding to the remote event, or (iii) a degree of association of the received query with the remote event; and
provide, based on the determined intent of the invitee user and the determined access level of the invitee user, an access to data associated with the smart environment to the second electronic device.

10. The first electronic device of claim 8, wherein the information on the invitee user and the host user is based on at least one of (i) a determination that the host user is included in a contact list of the invitee user, (ii) information related to a past communication between the invitee user and the host user, (iii) previously used voice-based assistance communication of the invitee user, (iv) or one or more contexts associated with the remote event.

11. The first electronic device of claim 8, wherein the instructions, when executed by the at least one processor individually or collectively, further cause the first electronic device to:
monitor, via one or more IoT devices in the smart environment, one or more ongoing activities within the smart environment in relation to the remote event; and
store, at a time instance corresponding to the remote event, information related to the monitored one or more ongoing activities in the NL database in a specified format.

12. The first electronic device of claim 11, wherein the information related to the monitored one or more ongoing activities is stored in the NL database for a duration until a completion of the remote event.

13. The first electronic device of claim 11, wherein a timing of the monitoring of the one or more ongoing activities is based on at least one of a start time of the remote event, an end time of the remote event, or a relation of the one or more ongoing activities with the remote event.

14. The first electronic device of claim 11, wherein the instructions, when executed by the at least one processor individually or collectively, further cause the first electronic device to:
correlate the received query with the one or more ongoing activities;
retrieve, from the NL database, one or more instances of the one or more activities that are correlated with the received query; and
determine the response to the received query based on the retrieved one or more instances.

15. A non-transitory computer readable medium having computer-executable instructions stored therein, which when executed by at least one processor, cause a first electronic device to perform a method comprising:
receiving, from a second electronic device associated with an invitee user, a query related to a remote event associated with a smart environment;
determining, based on information on the invitee user and a host user hosting the remote event, an access level of the invitee user to access the smart environment; and
transmitting, using the NL database, a response to the received query to the second electronic device based on the determined access level of the invitee user.

16. The non-transitory computer readable medium according to claim 15, wherein the method further comprises:
determining an intent of the invitee user based on at least one of (i) a determination that the invitee user is invited to the remote event, (ii) an action of the invitee user corresponding to the remote event, or (iii) a degree of association of the received query with the remote event; and
providing, based on the determined intent of the invitee user and the determined access level of the invitee user, an access to data associated with the smart environment to the second electronic device.

17. The non-transitory computer readable medium of claim 15, wherein the information on the invitee user and the host user is based on at least one of (i) a determination that the host user is included in a contact list of the invitee user, (ii) information related to a past communication between the invitee user and the host user, (iii) previously used voice-based assistance communication of the invitee user, or (iv) one or more contexts associated with the remote event.

18. The non-transitory computer readable medium according to claim 15, wherein the method further comprises:
monitoring, via one or more IoT devices in the smart environment, one or more ongoing activities within the smart environment in relation to the remote event; and
storing, at a time instance corresponding to the remote event, information related to the monitored one or more ongoing activities in the NL database in a specified format.

19. The non-transitory computer readable medium according to claim 18, wherein the information related to the monitored one or more ongoing activities is stored in the NL database for a duration until a completion of the remote event.

20. The non-transitory computer readable medium according to claim 18, wherein a timing of the monitoring of the one or more ongoing activities is based on at least one of a start time of the remote event, an end time of the remote event, or a relation of the one or more ongoing activities.
